(19) United States
(12) Patent Application Publication
(10) Pub. No.: US 2024/0385151 A1
(43) Pub. Date: Nov. 21, 2024

(54) ULTRA-WIDE DYNAMIC RANGE DIFFERENTIAL CONDUCTIVITY DETECTOR CIRCUIT FOR ION CHROMATOGRAPHY

(71) Applicant: DIONEX CORPORATION, Sunnyvale, CA (US)

(72) Inventors: George H. Tang, Saratoga, CA (US); Husam Al-Esawi, El Dorado Hills, CA (US)

(21) Appl. No.: 18/658,082

(22) Filed: May 8, 2024

Related U.S. Application Data
(60) Provisional application No. 63/502,678, filed on May 17, 2023.

(51) Int. Cl. G01N 30/64; G01N 30/96

(52) U.S. Cl. CPC G01N 30/64; G01N 2030/965

(57) ABSTRACT

A conductivity detector module for an ion chromatography system includes a detector cell configured to receive an eluent stream from the ion chromatography system, the detector cell including a first electrode and a second electrode in electrical contact with the eluent stream; a first current branch coupled to a first cell drive input and to the first electrode and providing a first cell output; and a second current branch coupled to a second cell drive input and to the second electrode and providing a second cell output, wherein the first cell drive input and the second cell drive input are of equal magnitude and opposite sign.

### CROSS REFERENCE TO RELATED APPLICATIONS

This application claims priority to and benefit of U.S. Provisional Application No. 63/502,678, filed on May 17, 2023, the disclosure of which is incorporated herein by reference in its entirety for any and all purposes.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### FIELD OF THE INVENTION

The present disclosure generally relates to the field of ion chromatography including ultra-wide dynamic range differential conductivity detector circuit for ion chromatography.

### BACKGROUND OF THE INVENTION

Ion chromatography (IC) is a widely used analytical technique for the determination of anionic and cationic analytes in various sample matrices. Conductivity detectors are often used in IC to detect anionic and cationic analytes.

The dynamic range can often be limited by the detection system. In some instances, the dynamic range limitation of the detection system can be caused by the saturation of the analog to digital conversion component (ADC). For example, a 16-bit analog to digital conversion (ADC) is limited to a maximum of 4.8 orders of magnitude (log 2\hat{ }16). This is because a 16-bit ADC has a range of possible digital output values from 0 to 65535 counts. When using such a component, one must typically adjust the gain of the detector, or that of the amplifier between the detector and the ADC input so that the detector produces a signal at the ADC input that corresponds to several digital counts. This is so that small peaks are large enough to register at least one bit on the digital counter. Otherwise, the small peaks with amplitudes that fall below that threshold will not be recorded, resulting in an error in the intensities measured. So, in practice, a 16-bit ADC has less than 4.8 orders of magnitude of dynamic range. Typically, the effective dynamic range would be about 3.9 orders of magnitude.

There is a need to develop detection and measurement systems that can operate over a high dynamic range, able to detect and measure signals over a wide range of intensities, from weak to strong intensities without suffering from saturation or an overly low detection threshold in the noise band. Furthermore, there is a need for a detection and measurement system that is capable of operating in real-time, enabling high speed operation to be facilitated whilst once again, operating under conditions such that saturation or low detection threshold levels are not an issue. Methods and apparatuses providing a simpler method of increasing the dynamic range while maintaining adequate resolution are required.

### SUMMARY

In a first aspect, a conductivity detector module for an ion chromatography system includes a detector cell configured to receive an eluent stream from the ion chromatography system. The detector cell includes a first electrode and a second electrode in electrical contact with the eluent stream. The conductivity detector module further includes a first current branch coupled to a first cell drive input and to the first electrode and providing a first cell output; and a second current branch coupled to a second cell drive input and to the second electrode and providing a second cell output. The first cell drive input and the second cell drive input are of equal magnitude and opposite sign.

In various embodiments of the first aspect, the detector cell does not have a ground electrode.

In various embodiments of the first aspect, the voltage across the detector cell is the difference between the first cell drive input and the second cell drive input.

In various embodiments of the first aspect, the first cell output and the second cell output correspond to the product of the current through the detector cell and the gain.

In various embodiments, an ion chromatography system includes the conductivity detector module of the first aspect; a cell drive DAC configured to provide the first cell drive input and the second cell drive input; and a cell current ADC configured to convert the first cell output and the second cell output to a digital output. In particular embodiments, the ion chromatography system further includes a control unit configured to compare the digital output with a signal range, wherein the control unit is configured to generate the cell drive level signal based upon the comparison and provide the cell drive level signal to the cell drive DAC. In particular embodiments, the control unit is configured to compare the digital output with a signal range wherein the control unit is configured to generate the cell drive level signal based upon the comparison and provide the cell drive level signal to the cell drive DAC to maintain the digital output of the cell current ADC within the signal range.

In a second aspect, a signal processing assembly for a conductivity detector of an ion chromatography system includes a cell drive DAC configure to provide a voltage drive voltage to a detector cell, the voltage amplitude based on a cell drive level signal. The detector cell is configured to receive an eluent stream from the ion chromatography system. The signal processing assembly further includes a differential cell drive and transimpedance amplifier circuit configured to amplify the output of the measurement cell; a cell current ADC configure to convert the output of the signal amplifier to a digital output; and a control unit configured to compare the digital output with a signal range, wherein the control unit is configured to generate the cell drive level signal based upon the comparison and provide the cell drive level signal to the cell drive DAC.

In various embodiments of the second aspect, the control unit adjusts generates the cell drive level signal to maintain the digital output within the signal range.

In various embodiments of the second aspect, the detector cell does not have a ground electrode.

In various embodiments of the second aspect, the detector cell includes a first electrode and a second electrode in electrical contact with the eluent stream; and the differential cell drive and transimpedance amplifier circuit includes: a first current branch coupled to a first cell drive input from the cell drive DAC and to the first electrode and providing a first cell output; and a second current branch coupled to a second cell drive input from the cell drive DAC and to the second electrode and providing a second cell output. In particular embodiments, the voltage across the detector cell is the difference between the first cell drive input and the second cell drive input. In particular embodiments, the first cell output and the second cell output correspond to the product of the current through the detector cell and the gain.

In a third aspect, a signal processing assembly for a conductivity detector of an ion chromatography system includes a cell drive DAC configure to provide a voltage drive voltage to a detector cell, the voltage amplitude based on a cell drive level signal, the detector cell configured to receive an eluent stream from the ion chromatography system; a differential cell drive and transimpedance amplifier circuit configured to amplify the output of the measurement cell; a cell current ADC configure to convert the output of the signal amplifier to a digital output; and a control unit including a ADC data range scaling logic and a filtering logic, the ADC range scaling logic operable to adjust the digital output of the cell current ADC to account for range scaling applied to the cell drive DAC by the cell drive signal level, the filtering logic operable to reduce high frequency noise, wherein the range scaling logic operates before the filtering logic.

In various embodiments of the third aspect, the control unit further includes decimator logic operable to reduce the sampling frequency, the decimator logic operates between the range scaling logic and the filtering logic.

In various embodiments of the third aspect, the control unit further includes a low latency channel for comparison of the digital output with a signal range, and to generate the cell drive level signal based upon the comparison and provide the cell drive level signal to the cell drive DAC. In particular embodiments, the control unit generates the cell drive level signal to maintain the digital output within the signal range.

In various embodiments of the third aspect, the detector cell includes a first electrode and a second electrode in electrical contact with the eluent stream; and the differential cell drive and transimpedance amplifier circuit includes a first current branch coupled to a first cell drive input from the cell drive DAC and to the first electrode and providing a first cell output; and a second current branch coupled to a second cell drive input from the cell drive DAC and to the second electrode and providing a second cell output. In particular embodiments, wherein the voltage across the detector cell is the difference between the first cell drive input and the second cell drive input. In particular embodiments, the first cell output and the second cell output correspond to the product of the current through the detector cell and the gain.

### BRIEF DESCRIPTION OF THE DRAWINGS

FIG. 1 illustrates an exemplary ion chromatography system, in accordance with various embodiments.

FIGS. 2, 3, and 4 illustrate an exemplary detector circuitry, in accordance with various embodiments.

FIG. 5 is a flow diagram illustrating an exemplary method for measuring a signal from a conductivity detector, in accordance with various embodiments.

### DETAILED DESCRIPTION

Embodiments of ultra-wide dynamic range differential conductivity detector circuit for ion chromatography are described herein.

The section headings used herein are for organizational purposes only and are not to be construed as limiting the described subject matter in any way.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless described otherwise, all technical and scientific terms used herein have a meaning as is commonly understood by one of ordinary skill in the art to which the various embodiments described herein belongs.

It will be appreciated that there is an implied “about” prior to the temperatures, concentrations, times, pressures, flow rates, cross-sectional areas, etc. discussed in the present teachings, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. It is to be understood that both the foregoing general description and the following detailed description are exemplary and explanatory only and are not restrictive of the present teachings.

As used herein, “a” or “an” also may refer to “at least one” or “one or more.” Also, the use of “or” is inclusive, such that the phrase “A or B” is true when “A” is true, “B” is true, or both “A” and “B” are true. Further, unless otherwise required by context, singular terms shall include pluralities and plural terms shall include the singular.

A “system” sets forth a set of components, real or abstract, comprising a whole where each component interacts with or is related to at least one other component within the whole.

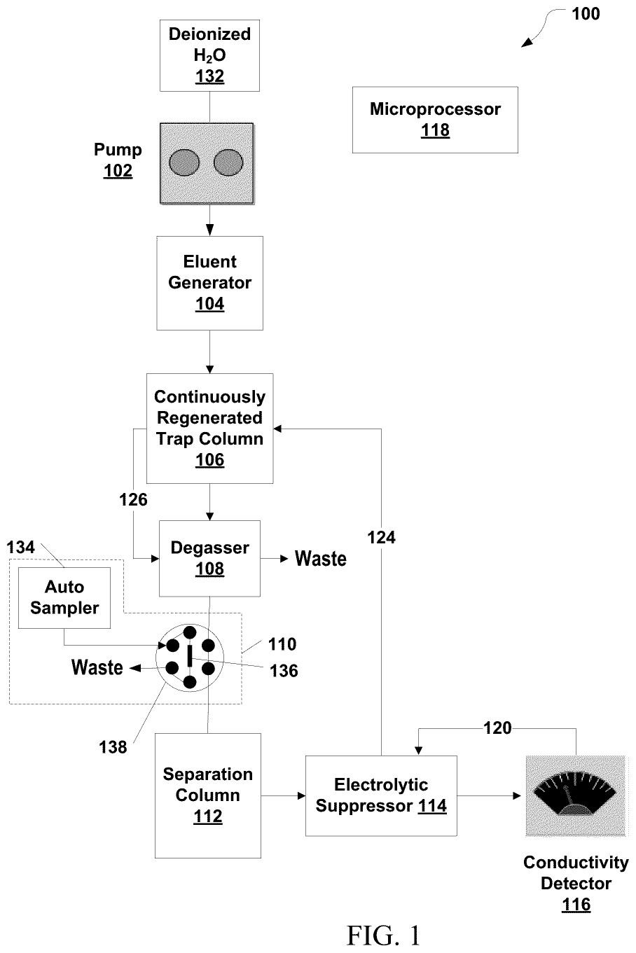

FIG. 1 illustrates an embodiment of a chromatography system 100. Chromatography system 100 may include a pump 102, an electrolytic eluent generator 104, a continuously regenerated trap column 106, a degasser 108, a sample injector 110, a chromatographic separation device 112, an electrolytic suppressor 114, a detector 116, and a microprocessor 118. Chromatographic separation device 112 may be in the form of a capillary column or an analytical column. Line 120 may be used to transfer the liquid from an output of detector 116 to an inlet of the electrolytic suppressor 114. Line 124 may be used to transfer liquid from an outlet of the regenerant channel of the electrolytic suppressor 114 to an inlet of the continuously regenerated trap column 106. Recycle line 126 can be used to transfer liquid from an outlet of the continuously regenerated trap column 106 to an inlet of the degasser 108. Liquid from the outlet of the degasser 108 can be directed to waste 128.

Pump 102 can be configured to pump a liquid from a liquid source 132, such as deionized water, and be fluidically connected to electrolytic eluent generator 104. Pump 102 can be configured to transport the liquid at a pressure ranging from about 20 PSI to about 15,000 PSI. Under certain circumstances, pressures greater than 15,000 PSI may also be implemented. It should be noted that the pressures denoted herein are listed relative to an ambient pressure (13.7 PSI to 15.2 PSI). Pump 102 may be in the form of a high-pressure liquid chromatography (HPLC) pump. In addition, pump 102 can also be configured so that the liquid only touches an inert portion of pump 102 so that a significant amount of impurities does not leach out. In this context, significant means an amount of impurities that would interfere with the intended measurement. For example, the inert portion can be made of polyether ether ketone (PEEK) or at least coated with a PEEK lining, which does not leach out a significant amount of ions when exposed to a liquid.

An eluent is a liquid that contains an acid, base, salt, or mixture thereof and can be used to elute an analyte through a chromatography column. In addition, an eluent can include a mixture of a liquid and a water miscible organic solvent, where the liquid may include an acid, base, salt, or combination thereof. Electrolytic eluent generator 104 is configured to generate a generant. A generant refers to a particular species of acid, base, or salt that can be added to the eluent. In an embodiment, the generant may be a base such as cation hydroxide or the generant may be an acid such as carbonic acid, phosphoric acid, acetic acid, methanesulfonic acid, or a combination thereof.

Referring to FIG. 1, eluent generator 104 can be configured to receive the liquid from pump 102 and then add a generant to the liquid. The liquid containing the generant can be outputted from eluent generator 104 to an inlet of continuously regenerated trap column 106.

Continuously regenerated trap column 106 is configured to remove cationic or anionic contaminants from the eluent. Continuously regenerated trap column 106 can include an ion exchange bed with an electrode at the eluent outlet. An ion exchange membrane stack can separate the eluent from a second electrode and contaminate ions can be swept through the ion exchange membrane stack towards the second electrode. The ion exchange membrane stack can include one or more ion exchange membranes. In various embodiments, anion removal can utilize an anion exchange bed with a cathode at the eluent outlet separated from an anode by an anion exchange membrane. Alternatively, cation removal can utilize a cation exchange bed with an anode at the eluent outlet separated from a cathode by a cation exchange membrane.

Degasser 108 may be used to remove residual gas. In an embodiment, a residual gas may be electrolytically generated such as hydrogen and oxygen. Degasser 108 may include a tubing section that is gas permeable and liquid impermeable such as, for example, amorphous fluoropolymers or more specifically Teflon AF. The flowing liquid can be outputted from degasser 108 to sample injector 110 with a substantial portion of the gas removed.

Sample Injector 110 can be used to inject a bolus of a liquid sample into an eluent stream. The liquid sample may include a plurality of chemical constituents (i.e., matrix components) and one or more analytes of interest. The sample injector 110 can include an auto sampler 134, sample loop 136, and a multiport valve 138. The auto sampler 134 can draw a sample from a sample container. The multiport valve 138 can be in a first position to allow the sample to fill the sample loop 136. After the sample loop 136 is filled to the desired level, the multiport valve can switch to a second position and the eluent stream can drive the sample onto the chromatographic separation device 112.

Chromatographic separation device 112 can be used to separate various matrix components present in the liquid sample from the analyte(s) of interest. Typically, chromatographic separation device 112 may be in the form of a hollow cylinder that contains a packed stationary phase. As the liquid sample flows through chromatographic separation device 112, the matrix components and target analytes can have a range of retention times for eluting off of chromatographic separation device 112. Depending on the characteristics of the target analytes and matrix components, they can have different affinities to the stationary phase in chromatographic separation device 112. An output of chromatographic separation device 112 can be fluidically connected to electrolytic suppressor 114.

Suppressor 114 can be used to reduce eluent conductivity background and enhance analyte response through efficient exchange of eluent counterions for regenerant ions. One type of suppressor is an electrolytic suppressor 114 can include an anode chamber, a cathode chamber, and an eluent suppression bed chamber separated by ion exchange membranes. The anode chamber and/or cathode chamber can produce regenerate ions or transport supplied regenerant ions. The eluent suppression bed chamber can include a flow path for the eluent separated from the regenerant by an ion exchange barrier and eluent counterions can be exchanged with regenerate ions across the ion exchange barrier. An output of electrolytic suppressor 114 can be fluidically connected to detector 116 to measure the presence of the separated chemical constituents of the liquid sample. The suppressor 114 can also be of the chemical kind that requires a chemical regenerant for operation. Any suppressor in the prior art is suited for the present application with multiple channels as configured.

Detector 116 may be in the form of ultraviolet-visible spectrometer, a fluorescence spectrometer, a refractive index detector, a radio flow detector, a chiral detector, an electrochemical detector, a conductivity detector, or a combination thereof. The detector 116 is preferably a non-destructive detector such as a conductivity detector that substantially preserves the eluent stream from the suppressor eluent output.

An electronic circuit may include microprocessor 118, a timer, and a memory portion. In addition, the electronic circuit may include a power supply that are configured to apply a controlling signal, respectively. Microprocessor 118 can be used to control the operation of chromatography system 100. Microprocessor 118 may either be integrated into chromatography system 100 or be part of a personal computer that communicates with chromatography system 100. Microprocessor 118 may be configured to communicate with and control one or more components of chromatography system such as pump 102, pump 130, eluent generator 104, sample injector 110, and detector 116. The memory portion may be used to store instructions to set the magnitude and timing of the current waveform with respect to the switching of sample injector 110 that injects the sample.

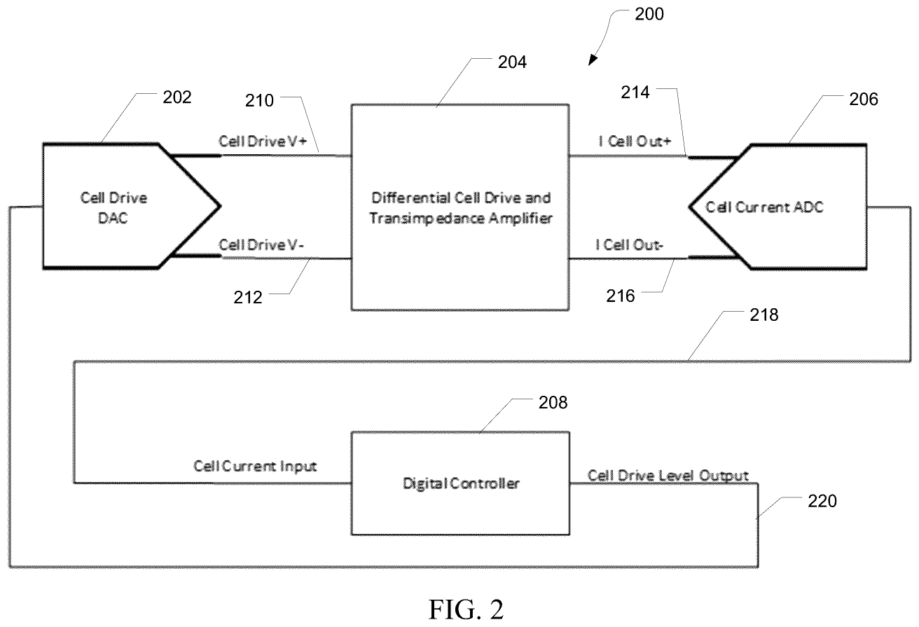

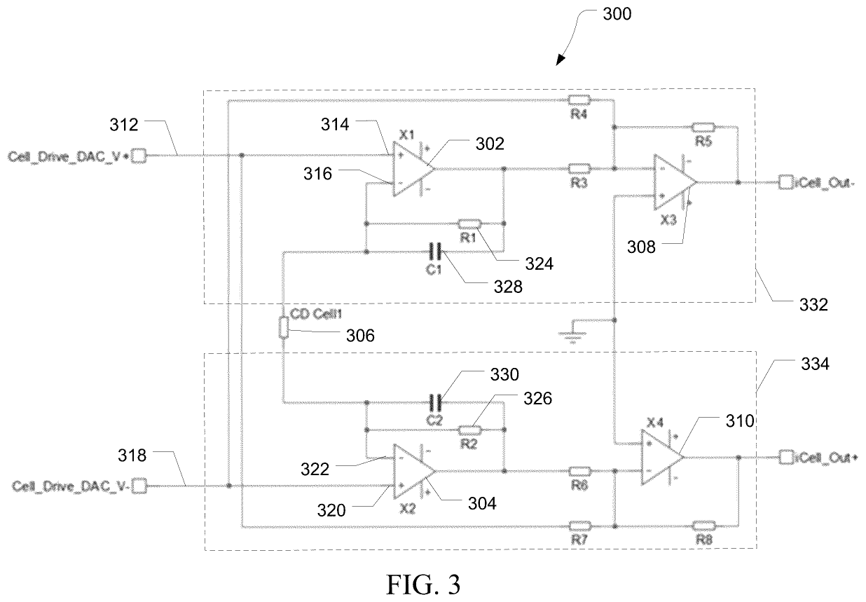

FIGS. 2 and 3 describe an approach for resolving small peaks when using a conductivity detector by implementing a wide dynamic range and common mode rejection. The large dynamic and adaptive range is needed to resolve small conductivity peaks in the presence of large conductivity peaks.

In ion chromatography detection, it is a challenge to resolve small peaks in the presence of large peaks. One approach is to switch between different analog to digital converter (ADC) ranges to provide the desired resolution. However, switching ranges results in artifacts, such as small peaks, in the chromatogram. In addition, this challenge is compounded when the system introduces noise.

FIG. 2 is a block diagram illustrative an exemplary detector circuit assembly 200, which may serve wholly or partially in place of detector 116. The detector assembly 200 includes a cell drive digital-analog converter (DAC) 202, a differential cell drive and transimpedance amplifier 204, a cell current ADC 206, and a digital controller 208.

The cell drive DAC 202 provides a positive drive voltage 210 and negative drive voltage 212 to the differential cell drive and transimpedance amplifier 204. The differential cell drive and transimpedance amplifier 204 provides a positive output 214 and a negative output 216 to the cell current ADC 206. The output 218 of the cell current ADC 206 is used by the digital controller to adjust the cell drive DAC 202 via cell drive level output 220.

The cell drive voltage DAC 202 works in concert with the cell current ADC 206 to have a combined dynamic range more than can be provided by the ADC 206 alone. The cell drive DAC 202 offers a smooth range change by making small adjustments to maintain a relative constant current through the cell for optimal signal-to-noise ratio at the input of the cell current ADC 206.

FIG. 3 illustrates a differential cell drive and transimpedance amplifier 300, such as differential cell drive and transimpedance amplifier 204. The differential cell drive and transimpedance amplifier 300 provides common mode rejection minimizing the impact of system noise on the conductivity measurement. Such an implementation eliminates the effect of ground loops and DC conductive paths. Also, differential cell drive and transimpedance amplifier 300 doubles the available cell drive voltage range for low conductivity measurements.

In the illustrated example, differential cell drive and transimpedance amplifier 300 is configured to receive the cell drive voltage from the DAC. Differential cell drive and transimpedance amplifier 300 includes amplifier 302, amplifier 304, detection cell 306, amplifier 308 and amplifier 310, amplifier 302 receives a positive cell drive voltage 312 at input 314. Due to negative feedback, the voltage at input 314 and input 316 are the same, amplifier 304 receives a negative cell drive voltage 318 at input 320. Due to negative feedback, the voltage at input 320 and input 322 are the same. As such, the voltage across the detection cell 306 is the differential input DAC voltage (positive cell drive voltage 312 minus negative cell drive voltage 318). Due to the high impedance input of the opamp, the current that flows through the detection cell 306 is the same as the current flowing through resistor 324 and resistor 326. The output of amplifier 302 and amplifier 304 is the sum of the voltage at the—input and the product of the detector cell current and resistor 324 or resistor 326. Amplifier 308 and amplifier 310 provide an inverting summing circuit which removes the cell drive voltages. The output of amplifier 308 and amplifier 310 represent the current of the detection cell 306*gain (gain=R1=R2). Capacitors 328 and 330 provide input capacitance compensation. Differential cell drive and transimpedance amplifier 300 can be divided into two symmetric current branches 332 and 334.

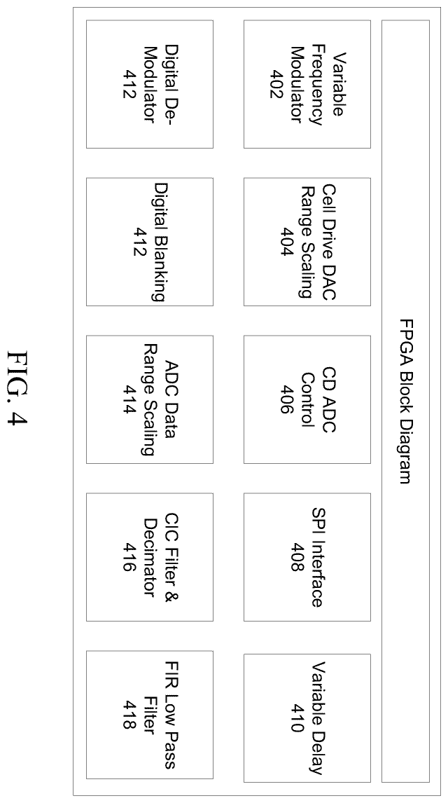

In various embodiments, digital controller 208 can include a programmable logic, such as an FPGA. FIG. 4 is a block diagram of an exemplary programmable logic 400. Programmable logic 400 can include a variable frequency modulator 402, cell drive DAC range scaling 404, CD ADC control 406, SPI interface 408, variable delay 410, digital demodulator 412, digital blanking 414, ADC data range scaling 416, CIC filter and decimator 418, and digital filter 420. Variable frequency modulator 402 can provide the modulation signal and adjust the frequency. Cell drive DAC range scaling 404 can control the range scaling on the DAC, as discussed in more detail later. CD ADC control 406 can control the ADC. SPI interface 408 can provide communication between the digital controller and other components, such as the ADC and the DAC. The digital demodulator 412 can demodulate the signal from the ADC. ADC data range scaling 416 can adjust the output of the ADC to account for the range scaling applied to the DAC. The CIC filter and decimator 418 can reducing the sampling frequency, such as from 128 kHz to 100 Hz and the digital filter 420 can remove high frequency noise. Significantly, the ADC data range scaling 416 is applied prior to the CIC filter and decimator 418 and the digital filter 420 so that the CIC filter and decimator 418 and the digital filter 420 only see values that are independent of the range scaling.

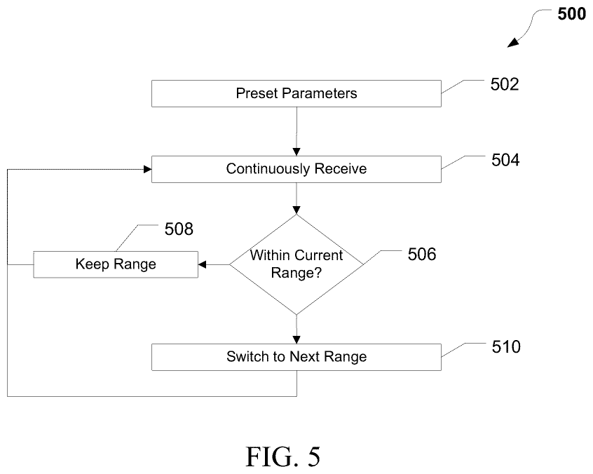

FIG. 5 provides an exemplary method 500 of adaptive control of the electrometer of a detector. At the commencement of method 500, step 802, a user or automation routine is configured to preset the parameters for the electronics, such as detector circuit assembly 200. Presetting the parameters for detector circuit assembly 200 may include one or more of determining or predefining a preferred dynamic input range based upon the capabilities of amplifier 204 and/or ADC 206 or setting the initial parameters of DAC 202. Once the parameters of detector circuit assembly 200 have been preset, at step 504, the chromatography system may be activated and detector circuit assembly 200 enabled to continuously receive the resulting measurement data. At step 506, digital controller 208 is configured to receive the cell current input voltage 218 from digital controller 208 and determine whether the current input voltage 218 is within the preferred dynamic range. As will be described below, various methods may be utilized to determine whether the current input voltage 218 is within the preferred dynamic range and automatically adjust the cell drive level output 220 in response to that determination. A user may pre-determine the various range thresholds for switching the cell drive level output 220.

In a first example, digital controller 208 analyzes the ADC output over multiple cycles, such as 4 cycles, to determine an average magnitude or other similar signal characteristic. In various embodiments, the signal can be modulated, such as at a 4 kHz modulation frequency. Averaging over 4 modulation cycles with a 4 kHz modulation frequency can provide a 1 msec response time, although faster or slower response times can be achieved by varying the modulation frequency and the number of cycles used for averaging. If the average magnitude is less than a lower threshold, such as less than about 45% of the maximum of a particular current input voltage range, the cell drive level output 220 is moved to the next lower range. In various embodiments, the lower threshold can be less than about 40%, such as less than about 35%, such as less than about 30%, even less than about 25% of the maximum of the current input voltage range Similarly, if the average magnitude is greater than an upper threshold, such as greater than about 85% of the maximum of the current input voltage range, the input offset is moved to the next higher range. In various embodiments, the upper threshold can be greater than about 90%, such as greater than about 95% of the maximum of a particular current input voltage range.

In a second example, digital controller 208 samples two voltage points Vp1 and Vp2 and analyzes the changing rate or trend of the signal (Vp1-Vp2) to predict a range where a future voltage point value may land. If the slope or trend rate is smaller than the slope or trend rate of the immediately preceding slope or trend rate, it can be predicted that future voltage points will not deviate significantly away from the existing range, therefore the input offset is kept in the same range. However, if the slope or trend rate is much larger than the slope or trend rate of the immediately preceding slope or trend rate, it can be predicted that future voltage points may deviate significantly away from the existing range and the input offset is accordingly moved to the next range.

In a third example, digital controller 208 includes software algorithms to continuously adjust the input offset to obtain the best linearity and resolution of ADC 330. Further, in this example, an infinite number of small ranges may be deployed to essentially receive and react to adjust the input offset in real-time. The range categorization and resolution may be adjusted which results in a stable and reliable detector signal acquisition and digitalization with improved signal to noise ratio. However, it should be understood that various other methods have been contemplated, such as using nonlinear methods (for example, ANN, fuzzy, etc.) to do predictive or trend diagnosis of the signal amplitude and power to achieve automatic and adaptive signal range switching in order to get the best quality detector signal with minimal errors.

As such, as described above, the method may either proceed to step 508 and keep the same signal range, or alternative move to step 810 and switch to the next, more accurate signal range using any of the example methods described. In various embodiments, the ranges can differ by a factor of 2. In various embodiments, the signal can be modulated, and the range change can be limited to the beginning of a modulation cycle to prevent glitches in the output.

It is to be understood that features described with regard to the various embodiments herein may be mixed and matched in any combination without departing from the spirit and scope of the disclosure. Although different selected embodiments have been illustrated and described in detail, it is to be appreciated that they are exemplary, and that a variety of substitutions and alterations are possible without departing from the spirit and scope of the present disclosure.

What is claimed is:

1. A conductivity detector module for an ion chromatography system comprising:
a detector cell configured to receive an eluent stream from the ion chromatography system, the detector cell including a first electrode and a second electrode in electrical contact with the eluent stream;
a first current branch coupled to a first cell drive input and to the first electrode and providing a first cell output; and
a second current branch coupled to a second cell drive input and to the second electrode and providing a second cell output,
wherein the first cell drive input and the second cell drive input are of equal magnitude and opposite sign.

2. The conductivity detector module of claim 1, wherein the detector cell does not have a ground electrode.

3. The conductivity detector module of claim 1, wherein the voltage across the detector cell is the difference between the first cell drive input and the second cell drive input.

4. The conductivity detector module of claim 1, wherein the first cell output and the second cell output correspond to the product of the current through the detector cell and the gain.

5. An ion chromatography system comprising:
the conductivity detector module of claim 1;
a cell drive DAC configured to provide the first cell drive input and the second cell drive input; and
a cell current ADC configured to convert the first cell output and the second cell output to a digital output.

6. The ion chromatography system of claim 5, further comprising a control unit configured to compare the digital output with a signal range, wherein the control unit is configured to generate the cell drive level signal based upon the comparison and provide the cell drive level signal to the cell drive DAC.

7. The ion chromatography system of claim 5, further comprising a control unit configured to compare the digital output with a signal range wherein the control unit is configured to generate the cell drive level signal based upon the comparison and provide the cell drive level signal to the cell drive DAC to maintain the digital output of the cell current ADC within the signal range.

8. A signal processing assembly for a conductivity detector of an ion chromatography system, comprising:
a cell drive DAC configure to provide a voltage drive voltage to a detector cell, the voltage amplitude based on a cell drive level signal, the detector cell configured to receive an eluent stream from the ion chromatography system;
a differential cell drive and transimpedance amplifier circuit configured to amplify the output of the measurement cell;
a cell current ADC configure to convert the output of the signal amplifier to a digital output; and
a control unit configured to compare the digital output with a signal range, wherein the control unit is configured to generate the cell drive level signal based upon the comparison and provide the cell drive level signal to the cell drive DAC.

9. The signal processing assembly for a conductivity detector of claim 8, wherein the control unit adjusts generates the cell drive level signal to maintain the digital output within the signal range.

10. The signal processing assembly for a conductivity detector of claim 8, wherein the detector cell does not have a ground electrode.

11. The signal processing assembly for a conductivity detector of claim 8, wherein:
the detector cell includes a first electrode and a second electrode in electrical contact with the eluent stream; and
the differential cell drive and transimpedance amplifier circuit includes:
a first current branch coupled to a first cell drive input from the cell drive DAC and to the first electrode and providing a first cell output; and
a second current branch coupled to a second cell drive input from the cell drive DAC and to the second electrode and providing a second cell output.

12. The signal processing assembly for a conductivity detector of claim 11, wherein the voltage across the detector cell is the difference between the first cell drive input and the second cell drive input.

13. The signal processing assembly for a conductivity detector of claim 11, wherein the first cell output and the second cell output correspond to the product of the current through the detector cell and the gain.

14. A signal processing assembly for a conductivity detector of an ion chromatography system, comprising:
a cell drive DAC configure to provide a voltage drive voltage to a detector cell, the voltage amplitude based on a cell drive level signal, the detector cell configured to receive an eluent stream from the ion chromatography system;
a differential cell drive and transimpedance amplifier circuit configured to amplify the output of the measurement cell;
a cell current ADC configure to convert the output of the signal amplifier to a digital output; and
a control unit including a ADC data range scaling logic and a filtering logic, the ADC range scaling logic operable to adjust the digital output of the cell current ADC to account for range scaling applied to the cell drive DAC by the cell drive signal level, the filtering logic operable to reduce high frequency noise, wherein the range scaling logic operates before the filtering logic.

15. The signal processing assembly of claim 14, wherein the control unit further includes decimator logic operable to reduce the sampling frequency, the decimator logic operates between the range scaling logic and the filtering logic.

16. The signal processing assembly of claim 14, wherein the control unit further includes a low latency channel for comparison of the digital output with a signal range, and to generate the cell drive level signal based upon the comparison and provide the cell drive level signal to the cell drive DAC.

17. The signal processing assembly of claim 16, wherein the control unit generates the cell drive level signal to maintain the digital output within the signal range.

18. The signal processing assembly for a conductivity detector of claim 14, wherein:
the detector cell includes a first electrode and a second electrode in electrical contact with the eluent stream; and
the differential cell drive and transimpedance amplifier circuit includes:
a first current branch coupled to a first cell drive input from the cell drive DAC and to the first electrode and providing a first cell output; and
a second current branch coupled to a second cell drive input from the cell drive DAC and to the second electrode and providing a second cell output.

19. The signal processing assembly for a conductivity detector of claim 18, wherein the voltage across the detector cell is the difference between the first cell drive input and the second cell drive input.

20. The signal processing assembly for a conductivity detector of claim 18, wherein the first cell output and the second cell output correspond to the product of the current through the detector cell and the gain.
